(19) United States
(12) Patent Application Publication
(10) Pub. No.: US 2011/0316682 A1
(43) Pub. Date: Dec. 29, 2011

(54) METHOD FOR ENHANCING SECURITY OF A VEHICLE

(76) Inventor: Clement Ting-Wei Pan, Taipei (TW)

(21) Appl. No.: 12/822,161

(22) Filed: Jun. 23, 2010

(51) Int. Cl. B60R 25/10; H04N 7/18

(52) U.S. Cl. 340/426.24; 348/E07.085; 348/148

(57) ABSTRACT

A vehicle includes at least one sensor. When the sensor of the vehicle is enabled or triggered, turn on the surveillance camera installed on the vehicle or near the vehicle. When an intruder triggers the sensor, use the surveillance camera to capture the images of the intruder. Thus the identity of the intruder can be identified through the captured images.

### BACKGROUND OF THE INVENTION

1. Field of the Invention

The present invention relates to a method for enhancing security of a vehicle using an alarm system of a vehicle.

2. Description of the Prior Art

Car alarm systems were developed due to frequent car theft after cars were introduced in the 19^{th} century. A typical car alarm system has a plurality of sensors for detecting car thefts, a siren for creating sound to indicate car theft events and an auxiliary battery for powering the sensors and siren so that the sensors and siren can still operate even if they are disconnected from the main battery of the car.

When an intruder tries to break into the car, one of the sensors may be triggered. Then the siren is activated to start wailing. This should scare off the intruder and alarm the car owner of the car theft if the car owner is nearby. However, if the car owner is far away from the car or if the car owner is deaf, the car owner may not hear the wailing, then the intruder may pretend to be the car owner and continue his work to break into the car.

Moreover, even if the car owner is able to hear the wailing, when the car owner returns to the car, the intruder may already run away. And damages may already be done to the car. Because the car owner did not keep an image of the intruder, it would be very difficult to find and identify the intruder.

### SUMMARY OF THE INVENTION

According to an embodiment of the present invention, a method for enhancing security of a vehicle comprises enabling at least one sensor of the vehicle, turning on at least one surveillance camera, triggering one of the at least one sensor, and using the at least one surveillance camera to capture at least one image when one of the at least one sensor is triggered.

### BRIEF DESCRIPTION OF THE DRAWINGS

FIG. 1 is a block diagram of a vehicle according to an embodiment of the present invention.

FIG. 2 is a flowchart of a method for enhancing security of the vehicle in FIG. 1 according to an embodiment of the present invention.

### DETAILED DESCRIPTION

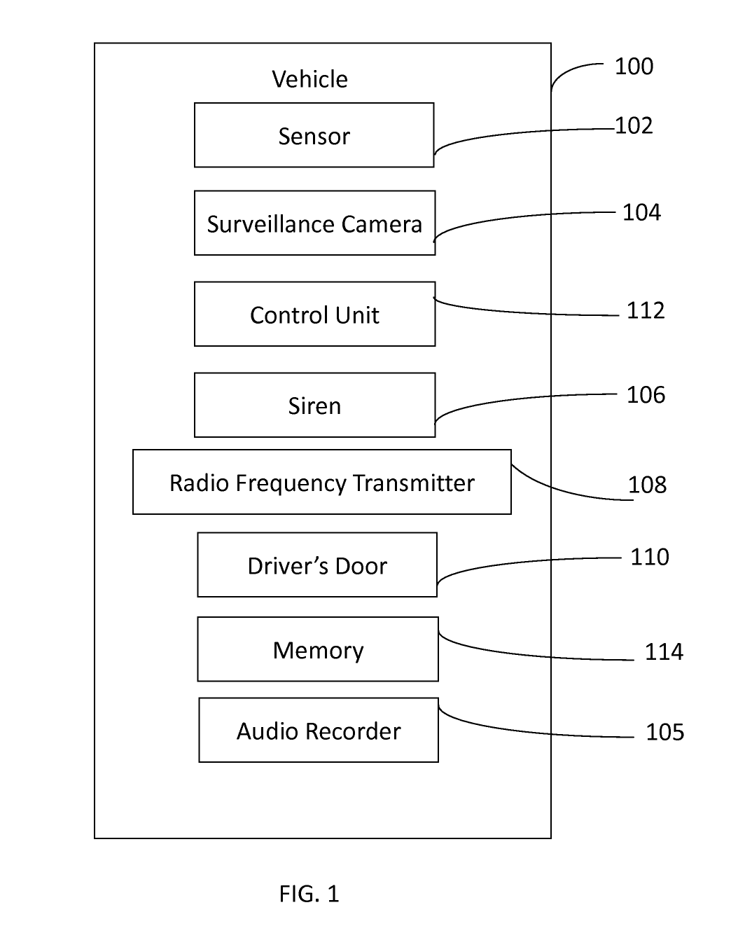

Please refer to FIG. 1. FIG. 1 is a block diagram of a vehicle 100 according to an embodiment of the present invention. The vehicle 100 may comprise at least one sensor 102, at least one surveillance camera 104, at least one audio recorder 105, a siren 106, a radio frequency transmitter 108, a driver's door 110, a control unit 112 and optionally a memory 114. The at least one sensor 102 may include a switch, pressure sensor and/or motion detector, etc. The at least one surveillance camera 104 may include a surveillance camera installed on the vehicle 100 for monitoring a portion of the vehicle 100, surveillance cameras installed on the vehicle 100 for monitoring substantially every corner of the vehicle 100, and/or at least one surveillance camera installed away from the vehicle 100 for monitoring the vehicle 100 from a distance away from the vehicle 100. For example, if the vehicle 100 is parked at a garage, a surveillance camera may be installed at a corner of the garage to monitor the vehicle 100. Regardless whether the surveillance camera 104 and/or the audio recorder 105 is installed on the vehicle 100 or installed away from the vehicle 100, the surveillance camera 104 can be a hidden camera, the audio recorder 105 can be a hidden recorder so as to hide from the intruder's sight and to avoid being damaged by the intruder. The radio frequency transmitter 108 is used to forward images taken by the surveillance camera 104 and/or voice recorded by the audio recorder 105 to a radio frequency receiver when one of the sensors 102 is triggered by a car theft. The radio frequency transmitter 108 may be installed in the surveillance camera 102 or may be separate from the surveillance camera 102 but coupled to the surveillance camera 102. The radio frequency transmitter 108 may also be part of the car phone. It can be any device which can forward the images taken by the surveillance camera 102 to the radio frequency receiver. The control unit 112 is used to monitor and coordinate the operation of the sensor 102, surveillance camera 104, siren 106 and radio frequency transmitter 108.

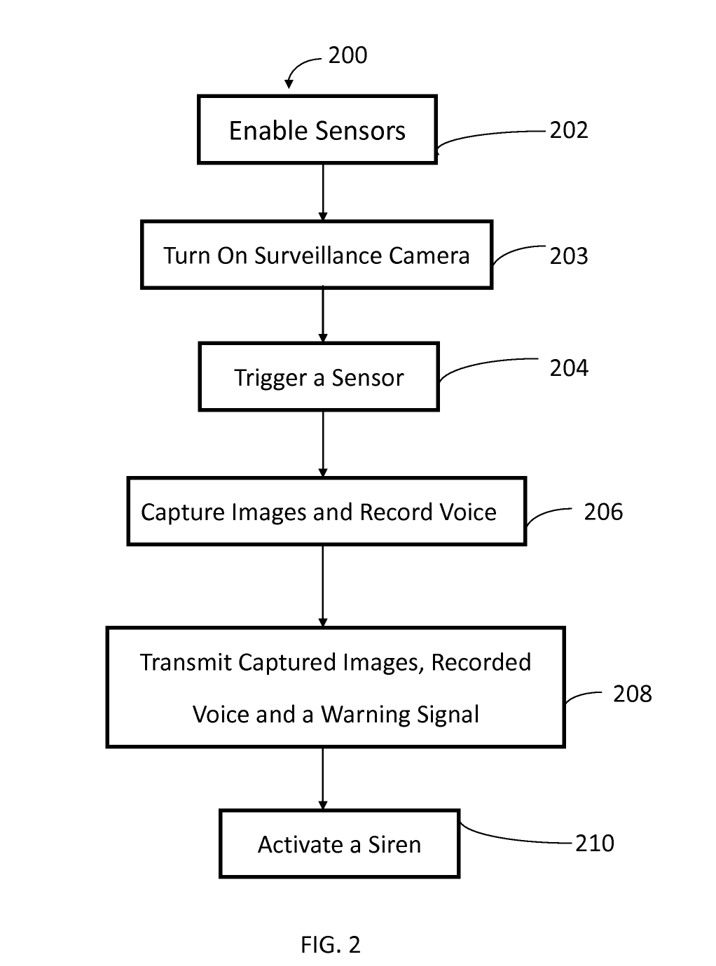

Please refer to FIG. 2. FIG. 2 is a flowchart of a method 200 for enhancing security of the vehicle 100 according to an embodiment of the present invention. The method 200 comprises the following steps:
Step 202: enabling at least one sensor 102 of the vehicle 100;
Step 203: turning on at least one surveillance camera 104;
Step 204: triggering one of the at least one sensor 102;
Step 206: using the surveillance camera 104 to capture images and using the audio recorder 105 to record voice when one of the at least one sensor 102 is triggered;
Step 208: using the radio frequency transmitter 108 of the vehicle 100 to transmit the images captured by the surveillance camera 104, the voice recorded by the audio recorder 105 and/or a warning signal to at least one destination;
Step 210: activating the siren 106 when one of the at least one sensor 102 is triggered.

In step 202, the sensor 102 can be enabled in the many different ways. One way to enable the senor 102 is by installing a switch at the driver's door 110. When the driver's door 110 is closed, an electrical connection is established through the switch to enable the sensor 102. In this case, when the driver's door 110 is opened without disabling the sensor 102 first, the sensor 102 is consequently triggered (step 204).

In step 203, the surveillance camera 104 is normally kept off until or a time period after the sensor 102 is triggered, thus the surveillance camera 104 would not consume too much power and battery life can be extended. Therefore, the security of the vehicle 100 can be monitored for a long period of time due to a long battery life span.

In another embodiment, the surveillance camera 104 is turned on when or a time period after the sensor 102 of the vehicle 100 is enabled instead of when or a time period after the sensor 102 is triggered. This will consume more power, but the surveillance camera 104 can start to capture images as soon as one of the at least one sensor 102 is triggered because no time is wasted to wait for the turning-on of the surveillance camera 104.

In step 204, the sensor 102 is normally triggered by the intruder. For example, when the intruder opens the driver's door 110 while the sensor 102 is not disabled, the electrical connection through the switch is terminated thereby triggering the sensor 102.

In steps 206 and 208, using the audio recorder 105 to record voice and sending the recorded voice are optional. But the use of the audio recorder 105 provides more information and evidence regarding the intrusion of the intruder.

In Step 208, besides sending the image to the at least one destination, the radio frequency transmitter 108 of the vehicle 100 can also forward a warning signal generated when or a time period after the sensor 102 is triggered to the at least one destination so as to inform the car owner and/or a monitor of the crime and notify the car owner and/or the monitor to check the images captured by the surveillance camera 104 and/or move to the crime scene.

Step 208 can also be performed by just using the radio frequency transmitter 108 of the vehicle 100 to send the warning signal, but not the images captured by the surveillance camera 104. In this case, once the car owner and/or the monitor of the crime is notified by the warning signal, the car owner and/or the monitor of the crime can move to the crime scene to stop the intruder. If the intruder has already run away, the car owner and/or the monitor of the crime can check the images stored in the surveillance camera 104 or the memory 114 to identify the intruder.

Moreover, step 208 can be performed by just using the radio frequency transmitter 108 of the vehicle 100 to send the images captured by the surveillance camera 104, but not the warning signal. In this case, the destination may generate a reminder signal such as vibration, noise and/or flash light upon receiving the images from the radio frequency transmitter 108 to remind the car owner and/or the monitor of the crime. Further, in another embodiment, the reminder signal is not generated, but the images can still be checked later on and the intruder can still be identified.

Steps 208 and 210 are optional. When steps 208 and 210 are both skipped, the images of the intruder trying to break into the vehicle 100 captured by the surveillance camera 104 are stored in the surveillance camera 104 and/or the memory 114 of the vehicle 100. Thus, the car owner and/or policeman can try to identify the intruder by reviewing the images captured by the surveillance camera 104 and request the intruder to compensate the car owner for the damage done to the vehicle 100 later on.

If only step 208 is skipped, then the images of the intruder trying to break into the vehicle 100 captured by the surveillance camera 104 are stored in the surveillance camera 104 and/or the memory 114 of the vehicle 100. Further the siren 106 wails to scare off the intruder to minimize the damage done to the vehicle 100.

If only step 210 is skipped, then as soon as the sensor 102 is triggered, the images captured by the surveillance camera 104 are sent to at least one the radio frequency receiver of a destination right away. The destination may be a PDA, a cellular phone, a smart phone, a personal computer, a notebook, a law enforcement security network, etc. Thus the car owner and/or policemen can view the images of the intruder and take care of the issue while not scaring off the intruder from the crime scene. And the policemen have a better chance to arrest the intruder while the intruder is still working to break into the vehicle.

If both steps 208 and 210 are performed, as soon as the sensor 102 is triggered, the images captured by the surveillance camera 104 are sent to the radio frequency receiver of a destination and the siren 106 wails right away. This may stop the intruder from further damaging the vehicle 100 and at the same time, keep an image of the intruder.

In short, once an intruder trying to break into the vehicle 100 triggers one of the sensors 102, the surveillance camera 104 can start to capture images of the vehicle 100. And the radio frequency transmitter 108 will transmit the images to the radio frequency receiver of a destination. The images may also be stored in the memory 114 in addition to the surveillance camera 104. Thus the vehicle owner can identify the intruder through the images from various storage devices and destinations. If personal valuables were stolen from the vehicle 100, by identifying the images of the intruder, the chance of restoring the personal valuables is greatly enhanced. Further, the surveillance camera 104 will keep the intruder away from the vehicle 100 thereby enhancing the security of the vehicle 100.

Those skilled in the art will readily observe that numerous modifications and alterations of the device and method may be made while retaining the teachings of the invention.

What is claimed is:

1. A method for enhancing security of a vehicle comprising:
enabling at least one sensor of the vehicle;
turning on at least one surveillance camera;
triggering one of the at least one sensor; and
using the at least one surveillance camera to capture at least one image when said one of the at least one sensor is triggered.

2. The method of claim 1 wherein turning on the at least one surveillance camera is turning on at least one surveillance camera of the vehicle and/or at least one surveillance camera near the vehicle.

3. The method of claim 1 wherein turning on the at least one surveillance camera comprises turning on at least one hidden camera.

4. The method of claim 1 further comprising using a radio frequency transmitter of the vehicle to transmit the at least one image captured when said one of the at least one sensor is triggered to at least one destination.

5. The method of claim 4 further comprising the destination generating a reminder signal when or after receiving the at least one image.

6. The method of claim 1 further comprising using at least one audio recorder to capture voice when the at least one surveillance camera captures the at least one image.

7. The method of claim 1 further comprising using a radio frequency transmitter of the vehicle to transmit the voice to at least one destination.

8. The method of claim 1 further comprising using a radio frequency transmitter of the vehicle to transmit a warning signal to at least one destination when said one of the at least one sensor is triggered.

9. The method of claim 1 further comprising activating a siren when said one of the at least one sensor is triggered.

10. The method of claim 1 wherein enabling the at least one sensor of the vehicle is enabling the at least one sensor of the vehicle when a driver's door of the vehicle is closed.

11. The method of claim 1 wherein turning on the at least one surveillance camera is turning on the at least one surveillance camera when or after the at least one sensor is enabled.

12. The method of claim 1 wherein turning on the at least one surveillance camera is turning on the at least one surveillance camera when or after said one of the at least one sensor is triggered.

13. The method of claim 1 further comprising storing the at least one image captured when said one of the at least one sensor is triggered in a memory of the vehicle.

14. A vehicle comprising:
at least one sensor;
means for turning on at least one surveillance camera;
means for enabling the at least one sensor; and
means for using the at least one surveillance camera to capture at least one image when one of the at least one sensor is triggered.

15. The vehicle of claim 14 wherein means for turning on the at least one surveillance camera is means for turning on at least one surveillance camera of the vehicle and/or at least one surveillance camera near the vehicle.

16. The vehicle of claim 14 further comprising:
a radio frequency transmitter for transmitting the at least one image and/or a warning signal generated by triggering said one of the at least one sensor.

17. The vehicle of claim 14 further comprising:
a siren; and
means for activating the siren when said one of the at least one sensor is triggered.

18. The vehicle of claim 14 further comprising a driver's door, wherein means for enabling the at least one sensor is means for enabling the at least one sensor when the driver's door of the vehicle is closed.

19. The vehicle of claim 14 wherein means for turning on the at least one surveillance camera is means for turning on the at least one surveillance camera when or after the at least one sensor is enabled.

20. The vehicle of claim 14 wherein means for turning on the at least one surveillance camera is means for turning on the at least one surveillance camera when or after said one of the at least one sensor is triggered.

21. The vehicle of claim 14 further comprising a memory for storing the at least one image captured when said one of the at least one sensor is triggered.
